(19) United States
(12) Patent Application Publication
(10) Pub. No.: US 2020/0393853 A1
(43) Pub. Date: Dec. 17, 2020

(54) MOVING PLATFORM AND CONTROL METHOD THEREFOR

(71) Applicant: SZ DJI TECHNOLOGY CO., LTD., Shenzhen (CN)

(72) Inventor: Jinsong Li, Shenzhen (CN)

(21) Appl. No.: 17/003,642

(22) Filed: Aug. 26, 2020

Related U.S. Application Data
(63) Continuation of application No. PCT/CN2018/079353, filed on Mar. 16, 2018.

(51) Int. Cl. G05D 1/10; B64C 39/02

(52) U.S. Cl. CPC G05D 1/1064; B64C 39/024

(57) ABSTRACT

A control method for a mobile platform includes obtaining a historical path that the mobile platform has traversed in response to a detection device of the mobile platform detecting an obstacle while the mobile platform is moving on a current path, controlling the mobile platform to move on the historical path to avoid the obstacle, and controlling the mobile platform to return from the historical path to the current path and continue moving in response to determining that an obstacle avoidance operation has completed.

### CROSS-REFERENCE TO RELATED APPLICATION

This application is a continuation of International Application No. PCT/CN2018/079353, filed Mar. 16, 2018, the entire content of which is incorporated herein by reference.

### TECHNICAL FIELD

The present disclosure relates to the field of control and, more particularly, to a moving platform (mobile platform) and a control method therefor.

### BACKGROUND

Mobile platforms (such as unmanned aerial vehicles (UAVs), unmanned vehicles (UVs), etc.) have been widely used to perform tasks such as shooting videos, logistics, surveying, inspection, plant protection, and security surveillance, etc.

A mobile platform can move in a planned path to perform tasks. When the mobile platform moves in the current path, there may be obstacles on the current path. Therefore, the mobile platform needs to bypass the obstacle. When it is determined that the obstacle has been bypassed, the mobile platform returns to the current path and continues moving to perform tasks. However, the existing obstacle bypass schemes have low intelligence and efficiency.

### SUMMARY

In accordance with the disclosure, there is provided a control method for a mobile platform including obtaining a historical path that the mobile platform has traversed in response to a detection device of the mobile platform detecting an obstacle while the mobile platform is moving on a current path, controlling the mobile platform to move on the historical path to avoid the obstacle, and controlling the mobile platform to return from the historical path to the current path and continue moving in response to determining that an obstacle avoidance operation has completed.

Also in accordance with the disclosure, there is provided a mobile platform including a detection device, a memory storing program instructions, and a processor configured to call the program instructions and execute the program instructions to obtain a historical path that the mobile platform has traversed in response to the detection device detecting an obstacle while the mobile platform is moving on a current path, control the mobile platform to move on the historical path to avoid the obstacle, and control the mobile platform to return from the historical path to the current path and continue moving in response to determining that an obstacle avoidance operation has completed.

### BRIEF DESCRIPTION OF THE DRAWINGS

The above and other features of the embodiments of the present disclosure will become more apparent through the following detailed description with the accompanying drawings.

FIG. 1 is a schematic diagram illustrating obstacle avoidance in existing technologies.

FIG. 2 is a schematic flow chart of a control method according to some example embodiments.

FIGS. 3A-3G are schematic diagrams of a solution for avoiding obstacles according to some example embodiments.

FIG. 4 is a block diagram of a mobile platform according to some example embodiments.

FIG. 5 is a schematic diagram of a computer-readable storage medium according to some example embodiments.

The drawings are not necessarily drawn to scale and focus on illustrating the technical principles of the embodiments of the present disclosure. In addition, similar reference numerals refer to similar elements throughout the drawings.

### DETAILED DESCRIPTION OF THE EMBODIMENTS

The technical solutions in the example embodiments of the present disclosure will be described clearly with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

A mobile platform may be any device that moves by its own power system. Specifically, the mobile platform may be a device that moves with the configured power system controlled by remote control information. For example, the mobile device may include an unmanned aerial vehicle (UAV), an unmanned boat, an unmanned vehicle, or a robot. The UAV is used as an example of the mobile platform for illustration.

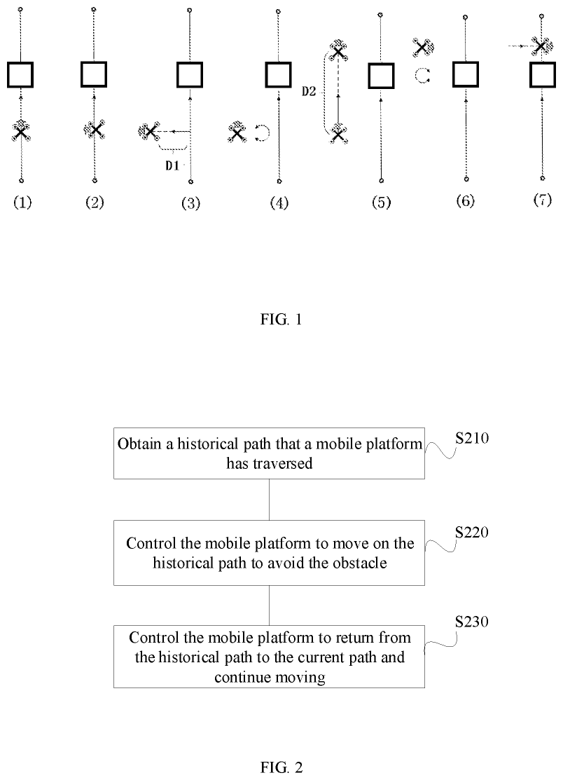

FIG. 1 illustrates an obstacle bypassing scheme of a UAV in existing technologies. As shown in FIG. 1, in pane (1), the UAV (represented by a cross) travels in a path. In pane (2), while a detection device of the UAV detects an obstacle in the front of the path, the UAV brakes and rotates the vehicle body thereof by 90 degrees to the left. Then, the UAV flies forward for a distance D1 and hovers, as shown in pane (3). Afterwards, the UAV rotates the vehicle body for 90 degrees to the right and returns to the direction same as the direction of the original path, as shown in pane (4). Thereafter, the UAV attempts to fly forward for a fixed distance D2 to try to avoid the obstacle as shown in pane (5). In pane (6), the UAV rotates 90 degrees to the right to detect whether an obstacle exist on the original path. If no, the UAV returns to the previous path, as shown in pane (7). If there is still an obstacle, the UAV returns to the step shown in pane (4), fly forward for a fixed distance D2 again and detect if there is an obstacle on the original path, until there are no obstacles on the original path, and then returns to the original path as shown in pane (7).

There are several problems with this bypassing scheme. For example, this bypassing scheme only considers the instantaneous measurement data or short-term measurement data of the detection device. The distance D2 of the UAV flight is only a fixed value and cannot be adaptively adjusted according to the size of the obstacle, which makes the process of obstacle avoidance not intelligent enough and inefficient.

A control method of a mobile platform is provided according to an embodiment of the present disclosure. FIG. 2 is a flow chart of the control method for the mobile platform according to the embodiment of the present disclosure. The control method can be implemented by, e.g., the mobile platform. More specifically, the control method can be implemented by, e.g., one or more processors of the mobile platform. The one or more processors can be one or more general-purpose processors or special-purpose processors.

As shown in FIG. 2, at S210, if an obstacle is detected by the detection device of the mobile platform while moving on the current path, a historical path that the mobile platform has traversed is obtained.

The mobile platform may include a detection device and the detection device can detect obstacles in the surrounding environment. During the movement of the mobile platform on the current path, the detection device can detect whether there is an obstacle, and further, the detection device can detect whether there is an obstacle that affects the safe movement of the mobile platform along the current path. If the mobile platform is a UAV, the UAV can detect whether there are obstacles that affect the safety of the UAV during flight along the current path through the detection device thereof. If an obstacle is detected, the mobile platform can obtain the historical movement path. In some cases, the historical path can be stored in the storage device of the mobile platform, and the processor of the mobile platform can obtain the historical path from the storage device. In some cases, the historical path may be stored in a control terminal that can communicate with the UAV, and the mobile platform may obtain the historical path from the control terminal. The control terminal may be one or more of a remote controller, a smart phone, a tablet computer, a laptop computer, and a wearable device (watch, bracelet, etc.).

In one embodiment, obtaining the historical path that the mobile platform has traversed includes obtaining the historical path that the mobile platform has traversed and meets preset requirements. Specifically, the storage device or the control terminal may store all the historical paths that the mobile platform has traversed since the moment of power-on, or may store the historical paths that the mobile platform has traversed within a preset period of time. All the historical paths that the mobile platform has traversed since the moment of power-on or the historical paths that the mobile platform has traversed within a preset period of time are determined to be the historical paths that meet the preset requirements.

Optionally, the historical path that meets the preset requirements includes the historical path closest to the current path. Specifically, the mobile platform determines the historical path closest to the current path from all historical paths that the mobile platform has traversed since the moment of power-on or the historical paths that the mobile platform has traversed within a preset period of time.

Optionally, the historical path that meets the preset requirements includes the historical path with no obstacle existing. Specifically, the mobile platform determines the historical path without obstacles from all historical paths that the mobile platform has traversed since the moment of power-on or the historical paths that the mobile platform has traversed within a preset period of time. Further, the historical path without obstacles indicate that there are no obstacles on the historical path that affect the safe movement of the mobile platform, that is, the obstacle avoidance operation is not performed during the entire movement of the mobile platform on the historical path.

In some embodiments, the historical path that meets the preset requirements includes a historical path that is closest to the current path and has no obstacles.

In one embodiment, the historical path and the current path are determined by a control terminal, which communicates with the mobile platform, through detecting the user's planning operation of the work area (the work area planning operation by the user). Specifically, with a UAV as the mobile platform, the user can perform a planning operation of the work area on the interactive interface of the control terminal to determine the work area where the UAV performs a task. For example, while the UAV performs a pesticide spraying task, the user can determine the work area for the UAV performing the pesticide spraying task by clicking on the interactive device of the control terminal.

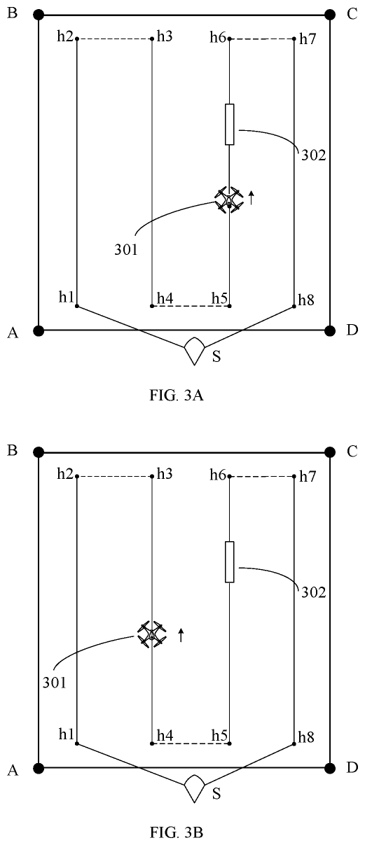

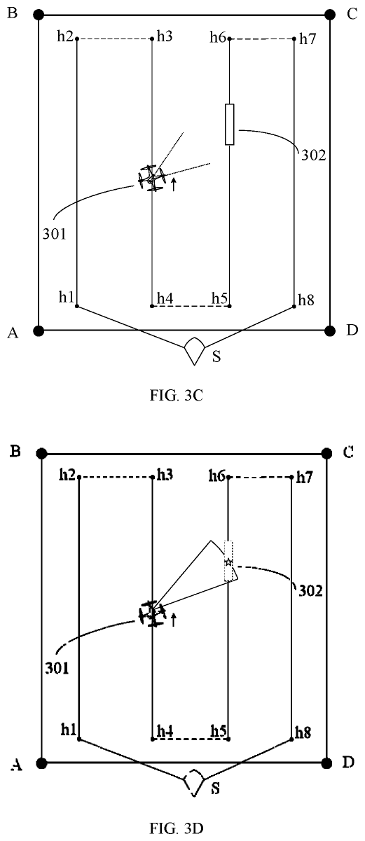

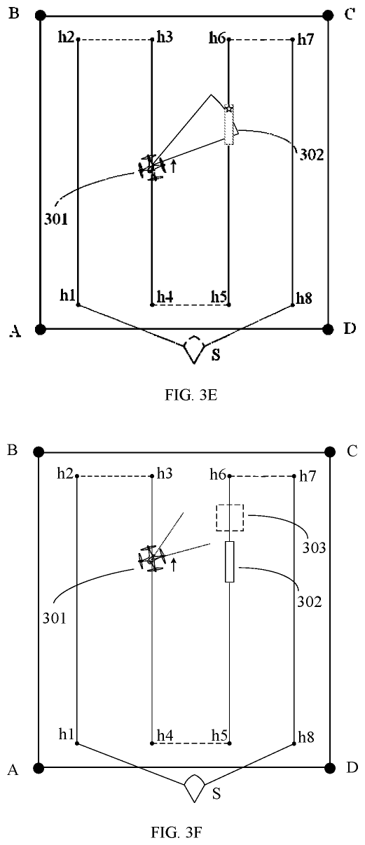

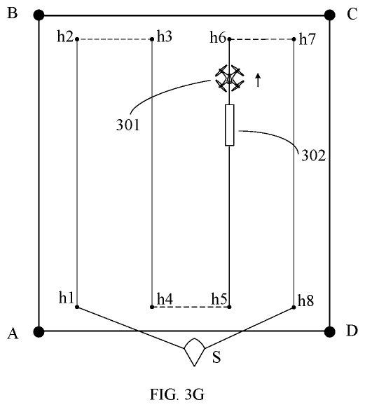

As shown in FIG. 3A, when the user clicks four points A, B, C, and D on the map displayed on the interactive device of the control terminal, the work area of the UAV is the area enclosed by points A, B, C, and D. The control terminal can plan the path for performing pesticide spraying tasks in the area enclosed by the four points A, B, C, and D. For example, the planned path is formed by waypoint 1 (h1), waypoint 2 (h2), waypoint 3 (h3) . . . waypoint 8 (h8). As shown in FIG. 3A, the UAV 301 took off from start point (S), has passed waypoint 1 (h1), waypoint 2 (h2), waypoint 3 (h3), waypoint 4 (h4), and waypoint 5 (h5), and is flying towards waypoint 6 (h6). Therefore, the historical path can be the path with waypoints 1 (h1) and waypoint 2 (h2) as endpoints and the path with waypoint 3 (h3) and waypoints 4 (h4) as endpoints, and the current path can be the path with waypoint 5 (h5) and waypoint 6 (h6) as the endpoints.

As shown in FIG. 3A, the UAV 301 may detect whether there is an obstacle within a certain distance on the current path while moving on the current path. This distance range can be set in advance, as long as the UAV can be safely stopped. For example, when the UAV 301 detects an obstacle 302 within a certain distance, the UAV 301 stops and starts an obstacle avoidance operation.

When the obstacle avoidance operation is started, the UAV 301 searches for a historical path that can bypass the obstacle from the historical paths that have been traversed (that is, the path with waypoints 1 and 2 as endpoints and the path with waypoint 3 and 4 as endpoints). As shown in FIG. 3B, the UAV 301 figures out that the path with waypoints 3 and 4 as endpoints is the closest historical path with no obstacles. Therefore, the UAV 301 moves to this path and continues to fly.

The detection device of the mobile platform can be any sensor device capable of detecting obstacles. Specifically, the detection device can be a millimeter wave radar, a lidar, an ultrasonic sensor, or a vision sensor (a monocular vision sensor or a binocular vision sensor, etc.). In some embodiments, the detection device is a millimeter wave radar or a lidar.

At S220, the mobile platform is controlled to move on a historical path to avoid the obstacle.

Specifically, when an obstacle is detected, the mobile platform brakes and moves from the current path to the historical path, then continues moving to avoid the obstacle on the current path. When the mobile platform moves on the historical path, the moving direction of the mobile platform is consistent with the moving direction of the mobile platform on the current path.

In one embodiment, during the movement of the mobile platform from the current path to the historical path, the heading of the mobile platform can be controlled to make the detection direction of the detection device face the moving direction of the mobile platform. Specifically, when the mobile platform moves on the current path, the detection direction of the detection device is the same as the moving direction in order to detect obstacles in the moving direction. When the mobile platform moves from the current path to the historical path, the mobile platform can adjust its own heading, and the detection direction of the detection device can be adjusted with the adjustment of the heading so that the detection direction of the detection device is consistent with the moving direction. Therefore, the mobile platform can detect obstacles that may exist in the process of moving from the current path to the historical path to ensure the safety of the mobile platform.

In one embodiment, during the movement of the mobile platform according to the historical path, the heading of the mobile platform can be controlled to make the detection direction of the detection device face the obstacle. The measurement data output by the detection device is used to determine whether the obstacle avoidance is completed. Specifically, the mobile platform can determine whether the obstacle avoidance is completed while moving on the historical path. When it is determined that the obstacle avoidance is completed, the mobile platform is controlled to return to the current path from the historical path and continue moving. When it is determined that the obstacle avoidance is not completed, the mobile platform is controlled to continue moving along the historical path. Further, during the movement of the mobile platform on the historical path, the mobile platform can control its own heading to make the detection direction of the detection device face the obstacle. During the movement of the mobile platform, the mobile platform can detect through the detection device based on the condition of the obstacle. The processor of the mobile platform obtains measurement data output by the detection device and determines in real time whether the obstacle avoidance is completed according to the measurement data. In this way, the distance that the mobile platform moves on the historical path is determined according to the situation of the obstacle and is not a fixed value. As a result, the intelligence degree and efficiency of avoidance are improved.

As shown in FIG. 3C, the UAV 301 moves forward on the historical path and continues to detect obstacles. During the movement, the UAV 301 points the nose toward the detected obstacle 302 and continues to observe the obstacles on the current route. This is particularly advantageous when using radar with limited detection range as the detection device.

At S230, when it is determined that the obstacle avoidance is completed, the mobile platform is controlled to return to the current path from the historical path and continue to move.

Specifically, when the mobile platform is moving on the historical path and it is determined that the obstacle avoidance is completed, that is, it is determined that it is okay to return to the current path, the mobile platform returns to the current path from the historical path and continues to move on the current path. In this way, the mobile platform returns to the current path to continue performing the task.

Further, determining whether the obstacle avoidance is completed according to the measurement data output by the detection device includes determining whether there is a safe area on the current path where the obstacle avoidance is completed according to the measurement data output by the detection device. When there is a safe area and the obstacle avoidance is determined to be completed, controlling the mobile platform to return from the historical path to the current path and continue to move includes controlling the mobile platform to return to the safe area on the current path from the historical path and continue moving. Specifically, the mobile platform obtains the measurement data output by the detection device in real time while moving along the historical path. At a certain moment, it is determined whether there is a safe area on the current path where the obstacle avoidance is completed according to the measurement data. In another word, it is determined according to the measurement data that there is an area on the current path that does not contain an obstacle. Therefore, it is determined that the mobile platform has completed the obstacle avoidance. The mobile platform can return to the safe area from the current position and continue to move along the current path from the safe area. The size of the safe area can be determined according to the size of the mobile platform. For example, a circumscribed quadrilateral of the mobile platform can be constructed, and the quadrilateral is used as the size of the safe area, so that the safe area can accommodate the mobile platform.

Optionally, controlling the heading of the mobile platform to make the detection direction of the detection device face the obstacle includes controlling the heading of the mobile platform to make the detection direction of the detection device face the obstacle while keeping the heading unchanged. Specifically, during the movement of the mobile platform on the current path, when an obstacle is detected, the mobile platform determines the position of the obstacle currently in the detection range of the detection device. The position can be a global position or a relative position (for example, a position relative to a reference point, which may be a position where the mobile platform is powered on). After the mobile platform moves from the current path to the historical path, the heading of the mobile platform can be controlled to make the detection direction of the detection device face the position of the determined obstacle and to remain unchanged while moving along the historical path. In another word, the detection direction of the detection device remains the same.

Optionally, controlling the heading of the mobile platform to make the detection direction of the detection device face the obstacle includes controlling the heading of the mobile platform at current time to make detection direction of the detection device face the obstacle according to the measurement data output by the detection device at previous time. Specifically, the mobile platform can determine information such as the size or position of an obstacle within the detection range according to the measurement data output by the detection device at previous time, and then adjust the heading of the mobile platform at current time according to the size or position of the obstacle. Therefore, the detection direction of the detection device faces the obstacle and the detection efficiency of the detection device is improved.

Further, controlling heading of the mobile platform at current time to make the detection direction of the detection device face the obstacle according to the measurement data output by the detection device at previous time includes determining the end of the obstacle in the detection range of the detection device at previous time according to the measurement data output by the detection device at previous time. At current time, the heading of the mobile platform is controlled to make the detection direction of the detection device face the end of the obstacle. Specifically, the mobile platform can determine the end of the obstacle in the detection range of the detection device at previous time according to the measurement data output by the detection device at previous time. The end of the obstacle can be the end, facing away from the moving direction of the mobile platform, of the obstacle in the detection range of the detection device. The mobile platform can determine the position of the end of the obstacle. At current time, the heading of the mobile platform is controlled according to the position of the end to make the detection direction of the detection device face the end of the obstacle.

As shown in FIG. 3D, when moving on the historical path, the nose of the UAV 301 faces the intersection point (represented by a star point in the figure) of the end of the obstacle 302 within the detection range and the expected path to return to. Moreover, as the UAV 301 continues moving on the historical path, the intersection point (star point) of the end of the obstacle in the detection range and the expected path to return to is refreshed constantly, as shown in FIG. 3E. Considering the limitation of the detection range, a safe area can be found faster with the method described above when the obstacle itself is relatively long.

As shown in FIG. 3F, the UAV 301 detects a safe area on the path to return to (a path with waypoints 5 and 6 as endpoints). As mentioned above, the size of the “safe area” can be determined based on the size of the UAV. For example, the circumscribed quadrilateral of the UAV 301 is used as the size of the safe area. As shown in FIG. 3F, the detection device of the UAV 301 detects whether a safe area has appeared on the path to return to. The detection device of the UAV 301 sequentially searches on the path to return to until there are no more obstacles in the detection range with the size of the safe area, and it can be determined that the safe area 303 is found.

After finding the safe area 303, the UAV 301 returns to the safe area on the path to return to (the path with waypoints 5 and 6 as endpoints), and continues to move on the path, as shown in FIG. 3G. Finally, the UAV 301 traverses the path with waypoints 5 (h5) and 6 (h6) as endpoints and the path with waypoints 7 (h7) and 8 (h8) as endpoints, and returns to the start point S. At this time, the operation task of the UAV 301 is completed.

By adopting the obstacle avoidance and bypassing strategy provided by the present disclosure, historical observation information can be used to find a path to go through. During the bypassing, the nose of the UAV always points to the intersection point of the path to return to and the obstacle, so that the UAV can find a safe returning area and return to the set route as soon as possible by reasonably using radar's working area with limited radar observation range. Therefore, the intelligence and reliability of the mobile platform to avoid obstacles can be effectively improved, and the efficiency of obstacles avoidance is also improved.

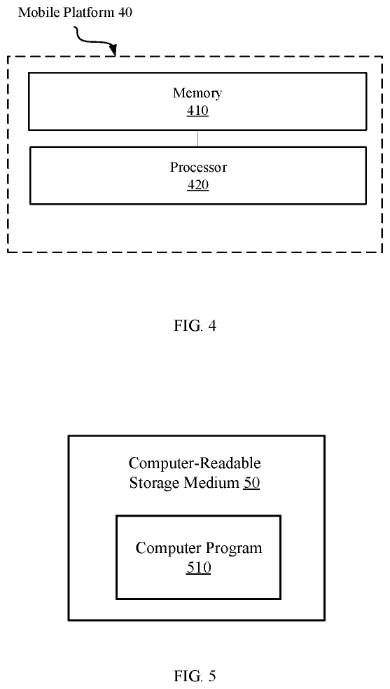

FIG. 4 is a block diagram illustrating a mobile platform 40 according to the embodiments of the present disclosure. The mobile platform may include a UAV, an unmanned ship, an unmanned vehicle or a robot. As shown in FIG. 4, the mobile platform 40 includes a memory 410 and a processor 420.

The memory 410 stores programs. For example, the memory 410 may be a random-access memory (RAM) or a read-only memory (ROM), or any combination thereof. The memory 410 may also include a persistent storage device, such as any one or a combination of magnetic storage, optical storage, solid-state storage, or even remotely installed storage.

The processor 420 may include any combination of one or more of a central processing unit (CPU), a multi-processor, a microcontroller, a digital signal processor (DSP), an application-specific integrated circuit, and etc.

The processor 420 can call programs stored in the memory 410. When the programs are executed, the processor 420 can perform the following operations: obtaining a historical path that the mobile platform has traversed when an obstacle is detected by the detection device of the mobile platform while moving on the current path of the mobile platform; controlling the mobile platform to move on the historical path to avoid the obstacle; and controlling the mobile platform to return from the historical path to the current path and continue moving when the obstacle avoidance is determined to be completed.

In one embodiment, the processor 420 executes programs stored in the memory 410 to obtain a historical path that the mobile platform has traversed and meets preset requirements. The historical path meeting preset requirements includes a historical path closest to the current path. In some embodiments, the historical path meeting the preset requirements includes a historical path with no obstacle existing.

In one embodiment, the processor 420 executes programs stored in the memory 410 to control the heading of the mobile platform to make the detection direction of the detection device face the moving direction of the mobile platform while the mobile platform moving from the current path to the historical path.

In one embodiment, the processor 420 executes programs stored in the memory 410 to control the heading of the mobile platform while the mobile platform moving along the historical path to make the detection direction of the detection device face the obstacle, and to determine whether the obstacle avoidance is completed according to the measurement data output by the detection device.

In one embodiment, the processor 420 executes programs stored in the memory 410 to determine whether there is a safe area on the current path where the obstacle avoidance is completed according to the measurement data output by the detection device. When there is a safe area, it is determined that the obstacle avoidance is completed.

In one embodiment, the processor 420 executes programs stored in the memory 410 to control the mobile platform to return from the historical path to the safe area on the current path and continue to move.

In one embodiment, the processor 420 executes programs stored in the memory 410 to control the heading of the mobile platform to make the detection direction of the detection device face the obstacle while keeping the heading unchanged.

In one embodiment, the processor 420 executes programs stored in the memory 410 to control the heading of the mobile platform at current time according to the measurement data output by the detection device at previous time, so that the detection direction of the detection device faces the obstacle.

In one embodiment, the processor 420 executes programs stored in the memory 410 to determine the end of the obstacle in the detection range of the detection device at previous moment according to the measurement data output by the detection device at previous moment, and control the heading of the mobile platform at the current time to make the detection direction of the detection device face the end of the obstacle.

In one embodiment, the size of the safe area can be determined according to the size of the mobile platform. For example, a circumscribed quadrilateral of the mobile platform can be constructed, and the quadrilateral is used as the size of the safe area.

The mobile platform provided in the embodiment of the present disclosure bypasses an obstacle by using historical paths and continuously detecting obstacles on the expected path. Even when the radar observation range is limited, the mobile platform provided in the embodiment of the present disclosure can still bypass obstacles quickly and smoothly.

In addition, the embodiments of the present disclosure can be implemented by products of computer programs. For example, the product of the computer program can be a computer-readable storage medium. A computer program is stored on a computer-readable storage medium. When the computer program is executed on a computing device, related operations can be performed to implement the above technical solutions provided in the embodiments of the present disclosure.

For example, FIG. 5 is a block diagram illustrating a computer-readable storage medium 50 according to an embodiment of the present disclosure. As shown in FIG. 5, the computer-readable storage medium 50 includes a computer program 510. When executed by at least one processor, the computer program 510 causes at least one processor to perform a method consistent with the disclosure, such as one of the example methods described above.

Those skilled in the art can understand that examples of the computer-readable storage medium 50 include, but are not limited to, a semiconductor storage medium, an optical storage medium, a magnetic storage medium, or any other form of computer-readable storage medium.

Example methods and related devices consistent with the present disclosure are described above in some embodiments. Those skilled in the art can understand that the methods described above are only exemplary. The methods of the embodiments of the present disclosure are not limited to those described above. For example, the above processes can be performed in an order different from that described or can be performed in parallel.

The embodiments of the present disclosure can be implemented by software, hardware, or a combination of both software and hardware. Such arrangements of the embodiments of the present disclosure are typically provided as software, code, and/or other data structures configured or encoded on a computer-readable medium such as an optical medium (like a CD-ROM), a floppy disk, or a hard disk; or are provided as one or multiple ROM or RAM or other medium with firmware or microcode on a PROM chip, or downloadable software images, shared databases, etc. in one or more modules. Software or firmware or such a configuration can be installed on a computing device, so that one or more processors in the computing device can execute the technical solutions described in the embodiments of the present disclosure.

In addition, each functional module or individual feature of the device used in each embodiment can be implemented or performed by circuits, which are typically one or more integrated circuits. Circuits designed to perform the functions described in this disclosure may include general-purpose processors, digital signal processors (DSPs), application-specific integrated circuits (ASICs) or general-purpose integrated circuits, field-programmable gate arrays (FPGAs), or other programmable logic devices, discrete gate or transistor-transistor logic, or discrete hardware components, or any combination of the above. The general-purpose processor may be a microprocessor, or the processor may be an existing processor, controller, microcontroller, or state machine. The general-purpose processor or each circuit can be configured by a digital circuit or can be configured by a logic circuit. In addition, when advanced technologies capable of replacing current integrated circuits appear due to advances in semiconductor technology, the embodiments of the present disclosure may also use integrated circuits obtained using the advanced technologies.

The program running on the device provided in the embodiments of the present disclosure may be a program that implements the functions of the embodiments of the present disclosure by controlling a central processing unit (CPU). The program or information processed by the program can be temporarily stored in volatile memory (such as random-access memory RAM), hard disk drive (HDD), non-volatile memory (such as flash memory), or other memory systems. The program for implementing the functions of the embodiments of the present disclosure may be recorded on a computer-readable recording medium. Corresponding functions can be implemented by a computer system calling programs recorded on the recording medium and executing the programs. The “computer system” can be a computer system embedded in the device, which includes an operating system or hardware (such as a peripheral device).

The embodiments of the present disclosure are described in detail with reference to the drawings. However, the specific structure is not limited to the above embodiments, and the embodiments of the present disclosure also include any design changes that do not deviate from the gist of the embodiments of the present disclosure. In addition, various modifications can be made to the description of the embodiments of the present disclosure within the scope of the claims. The embodiments obtained by appropriately combining the technical means of the embodiments of the disclosure are also included in the technical scope of the embodiments of the present disclosure. In addition, components having the same effects described in the above embodiments may be replaced with each other.

What is claimed is:

1. A control method for a mobile platform comprising:
obtaining a historical path that the mobile platform has traversed in response to a detection device of the mobile platform detecting an obstacle while the mobile platform is moving on a current path;
controlling the mobile platform to move on the historical path to avoid the obstacle; and
controlling the mobile platform to return from the historical path to the current path and continue moving in response to determining that an obstacle avoidance operation has completed.

2. The method of claim 1, wherein obtaining the historical path includes obtaining the historical path that the mobile platform has traversed and meets a preset requirement.

3. The method of claim 2, wherein the historical path that the mobile platform has traversed and meets the preset requirements includes the historical path that the mobile platform has traversed and is closest to the current path.

4. The method of claim 2, wherein the historical path that the mobile platform has traversed and meets the preset requirements includes the historical path that the mobile platform has traversed and has no obstacles.

5. The method of claim 1, further comprising:
controlling heading of the mobile platform to cause a detection direction of the detection device to face a moving direction of the mobile platform during a movement of the mobile platform from the current path to the historical path.

6. The method of claim 1, further comprising:
controlling heading of the mobile platform to cause a detection direction of the detection device to face the obstacle during a movement of the mobile platform on the historical path; and
determining whether the obstacle avoidance operation has completed based on measurement data output by the detection device.

7. The method of claim 6, wherein:
determining whether the obstacle avoidance operation has completed based on the measurement data output by the detection device includes:
determining whether a safe area exists on the current path beyond the obstacle according to the measurement data output by the detection device; and
determining the obstacle avoidance operation has completed in response to detecting the safe area; and
controlling the mobile platform to return from the historical path to the current path and continue moving includes controlling the mobile platform to return to the safe area and continue moving.

8. The method of claim 7, wherein a size of the safe area is determined according to a size of the mobile platform.

9. The method of claim 6, wherein controlling the heading of the mobile platform to cause the detection direction of the detection device to face the obstacle includes controlling the heading of the mobile platform to cause the detection direction of the detection device to face the obstacle while keeping the heading unchanged.

10. The method of claim 6, wherein controlling the heading of the mobile platform to cause the detection direction of the detection device to face the obstacle includes controlling the heading of the mobile platform at a current time to cause the detection direction of the detection device to face the obstacle according to measurement data output by the detection device at a previous time.

11. The method of claim 10, wherein controlling the heading of the mobile platform at the current time to cause the detection direction of the detection device to face the obstacle according to the measurement data output by the detection device at the previous time includes:
determining an end of the obstacle in a detection range of the detection device at the previous time according to the measurement data output by the detection device at the previous time; and
controlling the heading of the mobile platform at the current time to cause the detection direction of the detection device to face the end of the obstacle.

12. The method of claim 1, wherein the historical path and the current path are determined by a control terminal communicating with the mobile platform through detecting a work area planning operation by a user.

13. The method of claim 1, wherein the mobile platform includes an unmanned aerial vehicle, an unmanned ship, an unmanned vehicle, or a robot.

14. A mobile platform comprising:
a detection device;
a memory storing program instructions; and
a processor configured to call the program instructions and execute the program instructions to:
obtain a historical path that the mobile platform has traversed in response to the detection device detecting an obstacle while the mobile platform is moving on a current path;
control the mobile platform to move on the historical path to avoid the obstacle; and
control the mobile platform to return from the historical path to the current path and continue moving in response to determining that an obstacle avoidance operation has completed.

15. The mobile platform of claim 14, wherein the processor is further configured to execute the program instructions to obtain the historical path that the mobile platform has traversed by obtaining the historical path that the mobile platform has traversed and meets a preset requirement.

16. The mobile platform of claim 14, wherein the processor is further configured to control the heading of the mobile platform to cause a detection direction of the detection device to face a moving direction of the mobile platform during a movement of the mobile platform from the current path to the historical path.

17. The mobile platform of claim 14, wherein the processor is further configured to execute the program instructions to:
control heading of the mobile platform to cause a detection direction of the detection device to face the obstacle during a movement of the mobile platform on the historical path; and
determine whether the obstacle avoidance operation has completed based on measurement data output by the detection device.

18. The mobile platform of claim 17, wherein the processor is further configured to execute the program instructions to:
determine whether a safe area exists on the current path beyond the obstacle according to the measurement data output by the detection device;
determine the obstacle avoidance operation has completed in response to detecting the safe area; and
control the mobile platform to return to the safe area and continue moving.

19. The mobile platform of claim 18, wherein a size of the safe area is determined according to a size of the mobile platform.

20. The mobile platform of claim 17, wherein the processor is further configured to execute the program instructions to control the heading of the mobile platform at a current time to cause the detection direction of the detection device to face the obstacle according to the measurement data output by the detection device at a previous time.
